(19) United States
(12) Patent Application Publication
(10) Pub. No.: US 2008/0081287 A1
(43) Pub. Date: Apr. 3, 2008

(54) Chemically amplified resist material and pattern formation method using the same

(76) Inventors: Masayuki Endo, Osaka (JP); Masaru Sasago, Osaka (JP)

Correspondence Address: MCDERMOTT WILL & EMERY LLP, 600 13TH STREET, NW, WASHINGTON, DC, 20005-3096, US

(21) Appl. No.: 11/812,702

(22) Filed: Jun. 21, 2007

(30) Foreign Application Priority Data
Oct. 2, 2006 (JP) 2006-270431

(51) Int. Cl. G03C 1/73; G03C 5/00; G11B 7/24

(52) U.S. Cl. 430/281.1; 430/270.1; 430/325

(57) ABSTRACT

In the pattern formation method, a resist film is formed on a substrate by using a chemically amplified resist material including fumaric acid substituted by an acid labile group released by an acid; an alkali-soluble polymer soluble in an alkaline solution; and a photo-acid generator for generating an acid through irradiation with light. Subsequently, pattern exposure is carried out by selectively irradiating the resist film with exposing light, and a resist pattern is formed by developing the resist film after the pattern exposure.

### CROSS-REFERENCE TO RELATED APPLICATIONS

This application claims priority under 35 U.S.C. §119 on Patent Application No. 2006-270431 filed in Japan on Oct. 2, 2006, the entire contents of which are hereby incorporated by reference.

### BACKGROUND OF THE INVENTION

The present invention relates to a chemically amplified resist material for use in fabrication process or the like for semiconductor devices and a pattern formation method using the same.

In accordance with the increased degree of integration of semiconductor integrated circuits and downsizing of semiconductor devices, there are increasing demands for further rapid development of lithography technique. Currently, pattern formation is carried out through photolithography using exposing light of a mercury lamp, KrF excimer laser, ArF excimer laser or the like. Furthermore, attempts have been recently made in application to an ArF light source of immersion lithography in which pattern exposure is performed with a liquid provided between a resist film and a projection lens. Under these circumstances, it is regarded significant to increase the life time of ArF excimer laser lithography, and resist materials applicable to the ArF excimer laser are earnestly being developed.

In some studies, the composition of a polymer included in an ArF resist material is adjusted or modified for improving the resolution of a resist (see, for example, S. W. Yoon et al., “Influence of resin properties to resist performance at ArF lithography”, Proc. SPIE, vol. 5376, p. 583 (2004)).

Now, a pattern formation method using a conventional resist material applicable to the ArF light source will be described with reference to FIGS. 5A through 5D.

First, a positive chemically amplified resist material having the following composition is prepared:

Base polymer: poly((2-methyl-2-adamantyl methacrylate) (50 mol %)-(γ-butyrolactone methacrylate) (40 mol %)-(2-hydroxyadamantyl methacrylate) (10 mol %)) . . . 2 g

Photo-acid generator: triphenylsulfonium nonafluorobutane sulfonate . . . 0.06 g

Quencher: triethanolamine . . . 0.001 g

Solvent: propylene glycol monomethyl ether acetate . . . 20 g

Next, as shown in FIG. 5A, the aforementioned chemically amplified resist material is applied on a substrate 1 so as to form a resist film 2 with a thickness of 0.35 μm.

Then, as shown in FIG. 5B, pattern exposure is carried out by irradiating the resist film 2 with exposing light 4 of ArF excimer laser having NA of 0.68 through a mask 3.

After the pattern exposure, as shown in FIG. 5C, the resist film 2 is baked with a hot plate at a temperature of 105° C. for 60 seconds, and thereafter, the resultant resist film 2 is developed with a 0.26 N tetramethylammonium hydroxide developer. In this manner, a resist pattern 2a made of an unexposed portion of the resist film 2 and having a line width of 0.09 μm is formed as shown in FIG. 5D.

However, the resist pattern 2a obtained by the pattern formation method using the conventional resist material is in a defective shape and has low resolution, namely, low contrast. Thus, there is a problem that the pattern resolution and the pattern shape cannot be improved by, for example, modifying the conventional polymer composition.

When the resist pattern in such a defective shape is used for etching a target film, the resultant pattern of the target film is also in a defective shape, which disadvantageously lowers the productivity and the yield in the fabrication process for semiconductor devices.

### SUMMARY OF THE INVENTION

In consideration of the aforementioned conventional problem, an object of the invention is improving pattern resolution by increasing dissolution contrast attained by exposing light of a 300 nm band or shorter wavelength.

In order to achieve the object, according to the present invention, a chemically amplified resist material includes fumaric acid substituted by an acid labile group.

As a result of various experiments made on chemically amplified resist materials applicable to light of a 300 nm band or shorter wavelength such as an ArF light source, the present inventors have found the following: When a chemically amplified resist material includes fumaric acid that is dicarboxylic acid having a trans form molecular structure and is substituted by an acid labile group, the dissolution inhibiting effect of a resultant resist is increased owing to an intermolecular hydrogen bond between a polymer and the fumaric acid included in the chemically amplified resist material. Furthermore, the dissolution inhibiting effect is increased also because the glass transition temperature Tg of the resist is increased when the fumaric acid substituted by an acid labile group is included in the chemically amplified resist material. Since the dissolution inhibiting effect is thus increased, the dissolution contrast of the resist is improved. In the case where the chemically amplified resist material of this invention is used in the immersion lithography, the hydrophobic property of the resist is improved owing to a double bond included in the fumaric acid, and hence, a scanning speed attained in exposure is increased, resulting in reducing defects.

Considering that the fumaric acid is used in semiconductor fabrication process in particular, the fumaric acid used in the invention preferably has purity of approximately 99.9999% through 99.99%.

It is noted that both or one of two carboxylic acids included in the fumaric acid may be substituted by an acid labile group. The content of the fumaric acid substituted by an acid labile group in the resist material may be an amount for sufficiently exhibiting the dissolution inhibiting effect and is preferably 50 wt % or less on the basis of a base polymer, which does not limit the invention. In the case where exposing light is affected by absorption of the fumaric acid, it is necessary to consider the absorption of the exposing light.

The present invention was devised on the basis of the aforementioned finding and is specifically practiced as follows:

The first chemically amplified resist material of this invention includes fumaric acid substituted by a first acid labile group released by an acid; an alkali-soluble polymer soluble in an alkaline solution; and a photo-acid generator for generating an acid through irradiation with light.

Since the first chemically amplified resist material includes the fumaric acid substituted by the first acid labile group released by an acid, assuming that the resist material is, for example, a positive resist material, dissolution is accelerated in an exposed portion because the first acid labile group is released by an acid generated therein while the dissolution rate is lowered in an unexposed portion because the first acid labile group is not released therein. As a result, the contrast is improved in the development, so that the resist pattern can be formed in a good shape.

The second chemically amplified resist material of this invention includes fumaric acid substituted by a first acid labile group released by an acid; a polymer in which an alkali-soluble polymer soluble in an alkaline solution is substituted by a second acid labile group; and a photo-acid generator for generating an acid through irradiation with light.

In the second chemically amplified resist material, assuming that the resist material is, for example, a positive resist material, the dissolution rate attained in an unexposed portion is further lowered as compared with the case where an alkali-soluble polymer not substituted by a second acid labile group is used. This is because a —OR group (wherein R is the second acid labile group) is obtained by substituting a hydroxyl group (—OH group) of the alkali-soluble polymer by the second acid labile group, so as to reduce the alkali-solubility of the —OH group. In this manner, when the polymer substituted by the second acid labile group is used as the base polymer, the dissolution contrast is further improved.

For the same reason, the dissolution contrast is further improved when two carboxylic acids included in the fumaric acid are both substituted by the first acid labile group used for substituting the fumaric acid because the dissolution rate is thus further lowered than in the case where merely one of the carboxylic acids is substituted.

In the first or second chemically amplified resist material, the first or second acid labile group can be a t-butyl group, a t-butyloxycarbonyl group, a methoxymethyl group, an adamantyloxymethyl group, an ethoxyethyl group or a 2-methyl-2-adamantyl group. It is noted that the first acid labile group and the second acid labile group may be the same as or different from each other.

In the first or second chemically amplified resist material, the alkali-soluble polymer can be polyacrylic acid, polymethacrylic acid, polynorbornene methyl carboxylic acid, polynorbornene carboxylic acid, polynorbornene methyl hexafluoroisopropyl alcohol, polynorbornene hexafluoroisopropyl alcohol or polyvinyl phenol.

In the first or second chemically amplified resist material, the photo-acid generator can be triphenylsulfonium nonafluorobutane sulfonate, triphenylsulfonium trifluoromethane sulfonate or 1,3-diphenyl diazodisulfone.

The first pattern formation method of this invention includes the steps of forming, on a substrate, a resist film by using a chemically amplified resist material including fumaric acid substituted by a first acid labile group released by an acid, an alkali-soluble polymer soluble in an alkaline solution, and a photo-acid generator for generating an acid through irradiation with light; performing pattern exposure by selectively irradiating the resist film with exposing light; and forming a resist pattern by developing the resist film after the pattern exposure.

In the first pattern formation method, since the chemically amplified resist material includes the fumaric acid substituted by the first acid labile group released by an acid, assuming that the resist material is, for example, a positive resist material, dissolution is accelerated in an exposed portion because the first acid labile group is released by an acid generated therein while the dissolution rate is lowered in an unexposed portion because the first acid labile group is not released therein. As a result, the contrast is improved in the development, so that the resist pattern can be formed in a good shape.

The second pattern formation method of this invention includes the steps of forming, on a substrate, a resist film by using a chemically amplified resist material including fumaric acid substituted by a first acid labile group released by an acid, an alkali-soluble polymer soluble in an alkaline solution, and a photo-acid generator for generating an acid through irradiation with light; performing pattern exposure by selectively irradiating the resist film with exposing light with a liquid provided on the resist film; and forming a resist pattern by developing the resist film after the pattern exposure.

In the second pattern formation method, also when immersion lithography for irradiating a resist film with exposing light with a liquid provided on the resist film is employed, the contrast is improved in the development, so that the resist pattern can be formed in a good shape. In addition, since the hydrophobic property of the resist is improved by a double bond of the fumaric acid as described above, the scanning speed in the development can be improved and the number of defects is reduced.

In the first or second pattern formation method, the alkali-soluble polymer is preferably substituted by a second acid labile group released by an acid.

In the first or second pattern formation method, the first or second acid labile group can be a t-butyl group, a t-butyloxycarbonyl group, a methoxymethyl group, an adamantyloxymethyl group, an ethoxyethyl group or a 2-methyl-2-adamantyl group.

In the first or second pattern formation method, the alkali-soluble polymer can be polyacrylic acid, polymethacrylic acid, polynorbornene methyl carboxylic acid, polynorbornene carboxylic acid, polynorbornene methyl hexafluoroisopropyl alcohol, polynorbornene hexafluoroisopropyl alcohol or polyvinyl phenol.

In the first or second pattern formation method, the photo-acid generator can be triphenylsulfonium nonafluorobutane sulfonate, triphenylsulfonium trifluoromethane sulfonate or 1,3-diphenyl diazodisulfone.

In the second pattern formation method, the liquid can be water or an acidic solution.

In this case, the acidic solution can be a cesium sulfate (Cs₂SO₄) aqueous solution or a phosphoric acid (H₃PO₄) aqueous solution.

In the first pattern formation method, the exposing light can be extreme ultraviolet (EUV) or electron beam (EB).

In the first or second pattern formation method, the exposing light can be ArF excimer laser, KrF excimer laser, Xe₂ laser, F₂ laser, KrAr laser or Ar₂ laser.

In this manner, according to the chemically amplified resist material and the pattern formation method using the same of the invention, the dissolution contrast attained by exposing light of a 300 nm band or shorter wavelength can be improved, so that a resist pattern with high resolution can be formed in a good shape.

### BRIEF DESCRIPTION OF THE DRAWINGS

FIGS. 1A, 1B, 1C and 1D are cross-sectional views for showing procedures in a pattern formation method using a chemically amplified resist material according to Embodiment 1 of the invention;

FIGS. 2A, 2B, 2C and 2D are cross-sectional views for showing procedures in a pattern formation method using a chemically amplified resist material according to Embodiment 2 of the invention;

FIGS. 3A, 3B, 3C and 3D are cross-sectional views for showing procedures in a pattern formation method using a chemically amplified resist material according to Embodiment 3 of the invention;

FIGS. 4A, 4B, 4C and 4D are cross-sectional views for showing procedures in a pattern formation method using a chemically amplified resist material according to Embodiment 4 of the invention; and

FIGS. 5A, 5B, 5C and 5D are cross-sectional views for showing procedures in a conventional pattern formation method.

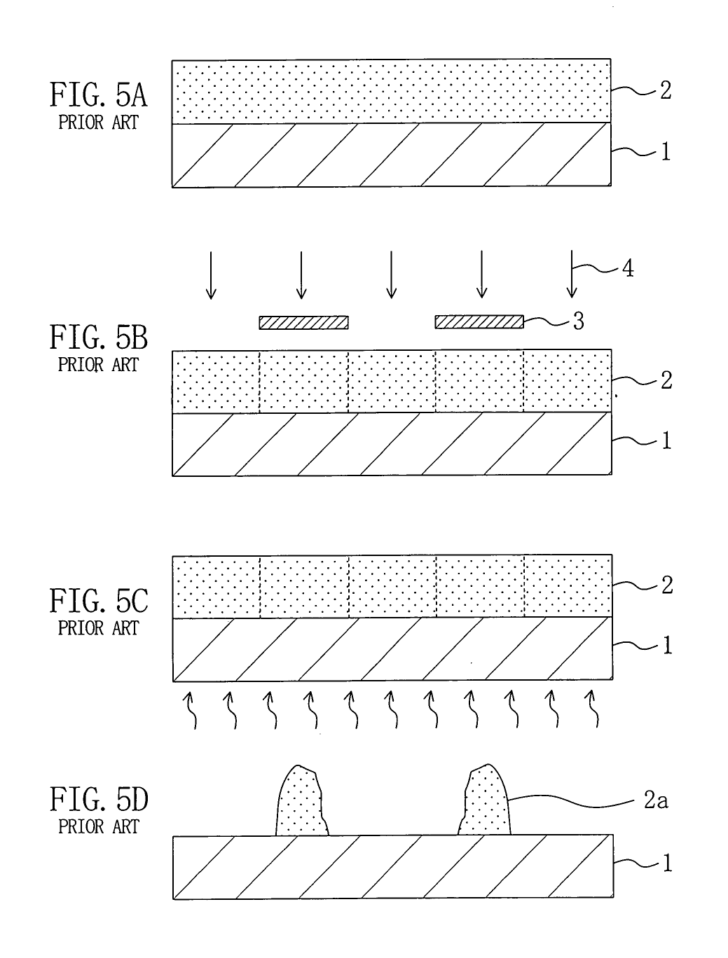

### DETAILED DESCRIPTION OF THE INVENTION

### Embodiment 1

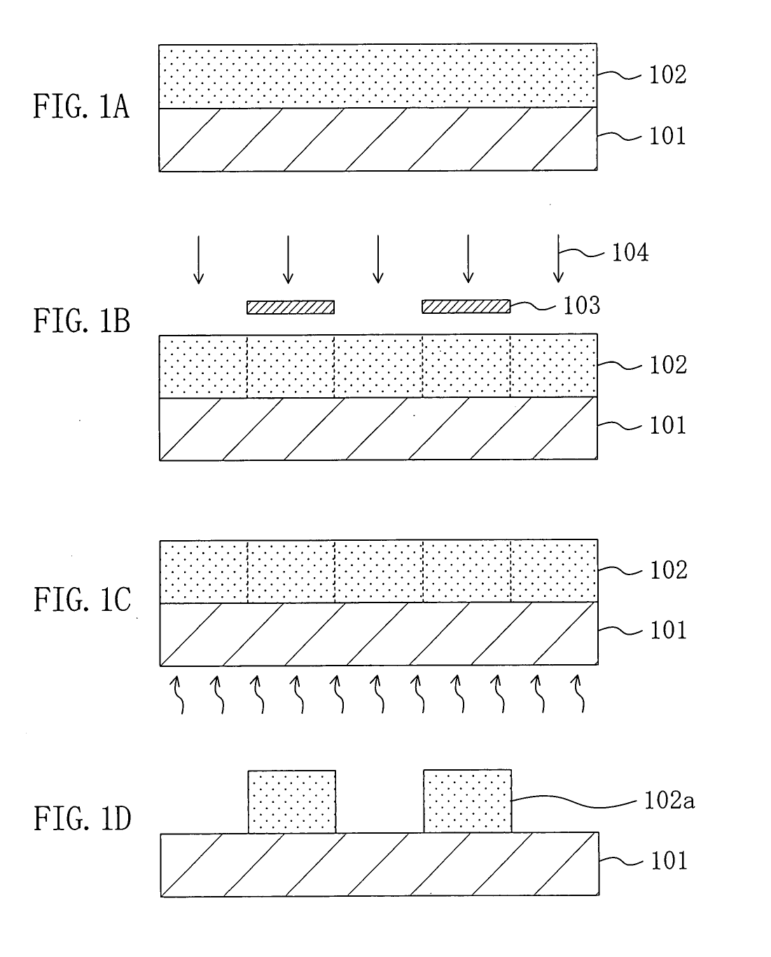

A chemically amplified resist material and a pattern formation method using the same according to Embodiment 1 of the invention will now be described with reference to FIGS. 1A through 1D.

First, a positive chemically amplified resist material having, for example, the following composition is prepared:

| | | |
|---|---|---|
| Base polymer: poly((methacrylic acid) | 2 | g |
| (30 mol %)-(γ-butyrolactone | | |
| methacrylate) (50 mol %)-(2-hydroxyadamantyl | | |
| methacrylate) (20 mol %)) | | |
| Dissolution inhibitor: di-t-butyl fumarate | 0.8 | g |
| Photo-acid generator: triphenylsulfonium nonafluorobutane | 0.06 | g |
| sulfonate | | |
| Quencher: triethanolamine | 0.001 | g |
| Solvent: propylene glycol monomethyl ether acetate | 20 | g |

Next, as shown in FIG. 1A, the aforementioned chemically amplified resist material is applied on a substrate 101 so as to form a resist film 102 with a thickness of 0.35 μm.

Then, as shown in FIG. 1B, pattern exposure is carried out by irradiating the resist film 102 with exposing light 104 of ArF excimer laser with NA of 0.68 through a mask 103.

After the pattern exposure, as shown in FIG. 1C, the resist film 102 is baked with a hot plate at a temperature of 105° C. for 60 seconds. Thereafter, the resultant resist film 102 is developed with a 0.26 N tetramethylammonium hydroxide developer. Thus, a resist pattern 102a made of an unexposed portion of the resist film 102, having a line width of 0.09 μm and having high resolution is formed as shown in FIG. 1D.

In this manner, according to Embodiment 1, the chemically amplified resist material includes the dissolution inhibitor of the di-t-butyl fumarate, that is, fumaric acid substituted by an acid labile group of a t-butyl group. Therefore, the dissolution is accelerated in an exposed portion of the resist film 102 because the t-butyl group is released by an acid generated from the photo-acid generator therein, and on the other hand, the dissolution rate is lowered in an unexposed portion because no t-butyl group is released therein. As a result, the contrast is improved in the resist film 102 in the development, so that the resist pattern 102a can be formed in a good shape.

### Embodiment 2

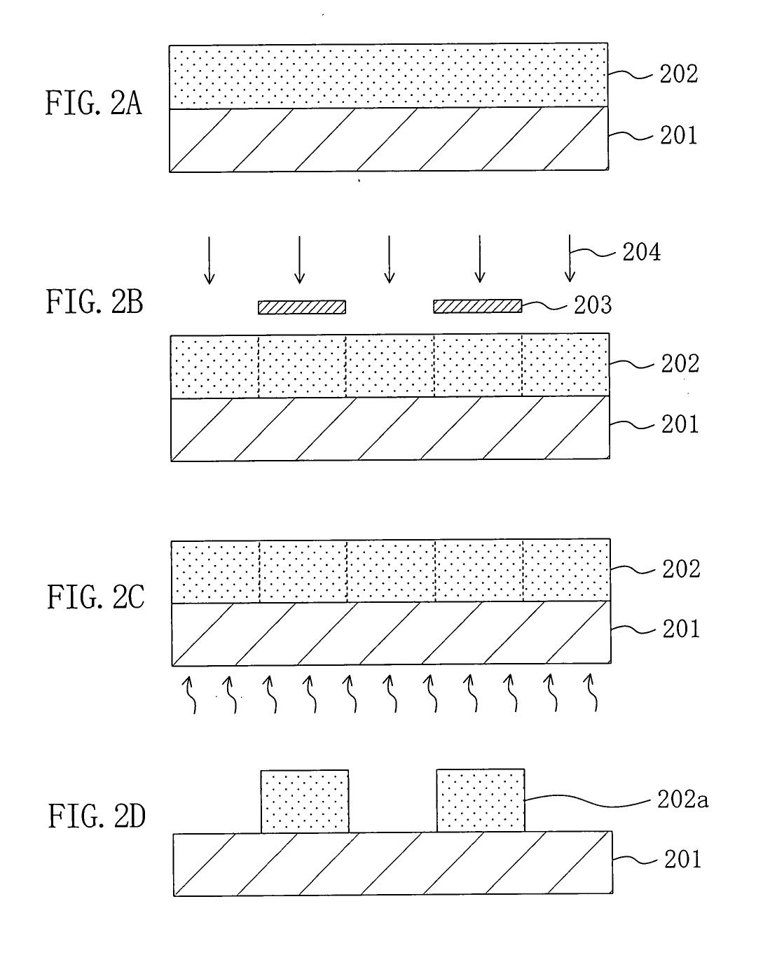

A chemically amplified resist material and a pattern formation method using the same according to Embodiment 2 of the invention will now be described with reference to FIGS. 2A through 2D.

First, a positive chemically amplified resist material having, for example, the following composition is prepared:

| | | |
|---|---|---|
| Base polymer: poly((2-methyl-2-adamantyl methacrylate) | 2 | g |
| (50 mol %)-(γ-butyrolactone methacrylate) (40 mol %)-(2- | | |
| hydroxyadamantyl methacrylate) (10 mol %)) | | |
| Dissolution inhibitor: di-t-butyl fumarate | 0.5 | g |
| Photo-acid generator: triphenylsulfonium | 0.06 | g |
| nonafluorobutane sulfonate | | |
| Quencher: triethanolamine | 0.001 | g |
| Solvent: propylene glycol monomethyl ether acetate | 20 | g |

Next, as shown in FIG. 2A, the aforementioned chemically amplified resist material is applied on a substrate 201 so as to form a resist film 202 with a thickness of 0.35 μm.

Then, as shown in FIG. 2B, pattern exposure is carried out by irradiating the resist film 202 with exposing light 204 of ArF excimer laser with NA of 0.68 through a mask 203.

After the pattern exposure, as shown in FIG. 2C, the resist film 202 is baked with a hot plate at a temperature of 105° C. for 60 seconds. Thereafter, the resultant resist film 202 is developed with a 0.26 N tetramethylammonium hydroxide developer. Thus, a resist pattern 202a made of an unexposed portion of the resist film 202, having a line width of 0.09 μm and having high resolution is formed as shown in FIG. 2D.

In this manner, according to Embodiment 2, the chemically amplified resist material includes the dissolution inhibitor of the di-t-butyl fumarate, that is, fumaric acid substituted by a first acid labile group of a t-butyl group. Therefore, the dissolution is accelerated in an exposed portion of the resist film 202 because the t-butyl group is released by an acid generated from the photo-acid generator therein, and on the other hand, the dissolution rate is lowered in an unexposed portion because no t-butyl group is released therein. As a result, the contrast is improved in the resist film 202 in the development, so that the resist pattern 202a can be formed in a good shape.

In addition, the base polymer is substituted by a second acid labile group, that is, a 2-methyl-2-adamantyl group in this embodiment, and hence, the dissolution inhibiting effect attained in the unexposed portion can be further increased. Specifically, the dissolution rate attained in the unexposed portion is further lowered, so as to further improve the contrast.

### Embodiment 3

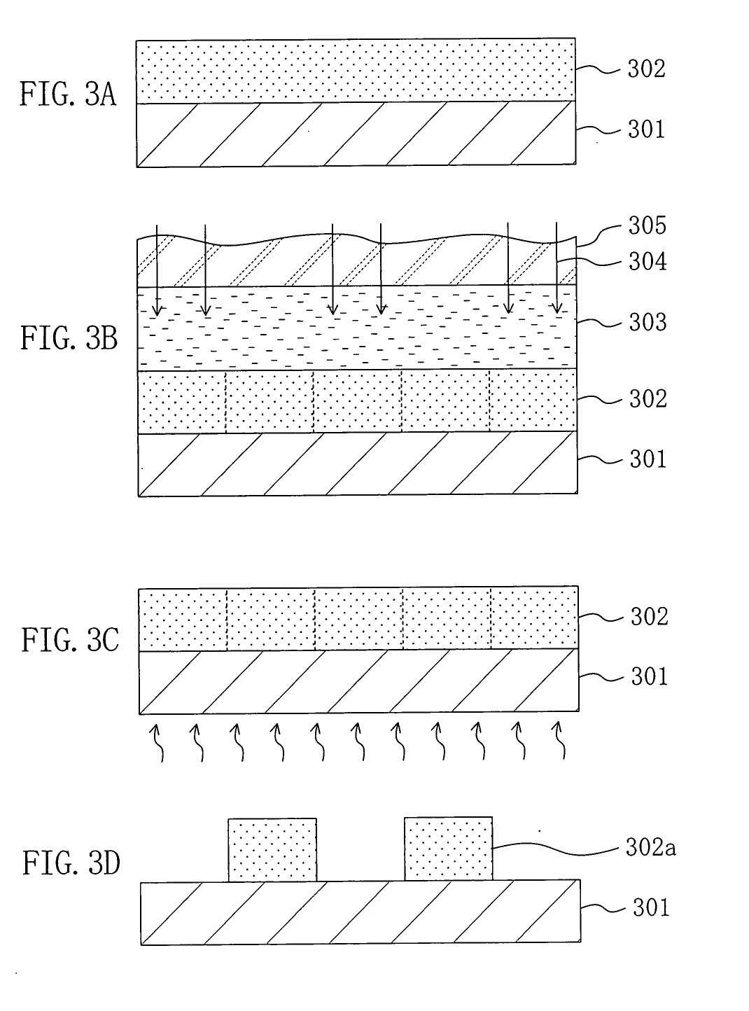

A chemically amplified resist material and a pattern formation method using the same according to Embodiment 3 of the invention will now be described with reference to FIGS. 3A through 3D.

First, a positive chemically amplified resist material having, for example, the following composition is prepared:

| | | |
|---|---|---|
| Base polymer: poly((methacrylic acid) (30 mol %)- | 2 | g |
| (γ-butyrolactone methacrylate) (50 mol %)- | | |
| (2-hydroxyadamantyl methacrylate) (20 mol %)) | | |
| Dissolution inhibitor: di-adamantyloxymethyl fumarate | 0.6 | g |
| Photo-acid generator: triphenylsulfonium | 0.06 | g |
| trifluoromethane sulfonate | | |
| Quencher: triethanolamine | 0.001 | g |
| Solvent: propylene glycol monomethyl ether acetate | 20 | g |

Next, as shown in FIG. 3A, the aforementioned chemically amplified resist material is applied on a substrate 301 so as to form a resist film 302 with a thickness of 0.35 μm.

Then, as shown in FIG. 3B, an immersion liquid 303 of water is provided between the resist film 302 and a projection lens 305. In this state, pattern exposure is carried out by irradiating the resist film 302 with exposing light 304 of ArF excimer laser with NA of 0.68 through a mask not shown.

After the pattern exposure, as shown in FIG. 3C, the resist film 302 is baked with a hot plate at a temperature of 115° C. for 60 seconds. Thereafter, the resultant resist film 302 is developed with a 0.26 N tetramethylammonium hydroxide developer. Thus, a resist pattern 302a made of an unexposed portion of the resist film 302, having a line width of 0.09 μm and having high resolution is formed as shown in FIG. 3D.

In this manner, according to Embodiment 3, the chemically amplified resist material includes the dissolution inhibitor of the di-adamantyloxymethyl fumarate, that is, fumaric acid substituted by an acid labile group of an adamantyloxymethyl group. Therefore, the dissolution is accelerated in an exposed portion of the resist film 302 because the adamantyloxymethyl group is released by an acid generated from the photo-acid generator therein, and on the other hand, the dissolution rate is lowered in an unexposed portion because no adamantyloxymethyl group is released therein. As a result, the contrast is improved in the resist film 302 in the development, so that the resist pattern 302a can be formed in a good shape.

### Embodiment 4

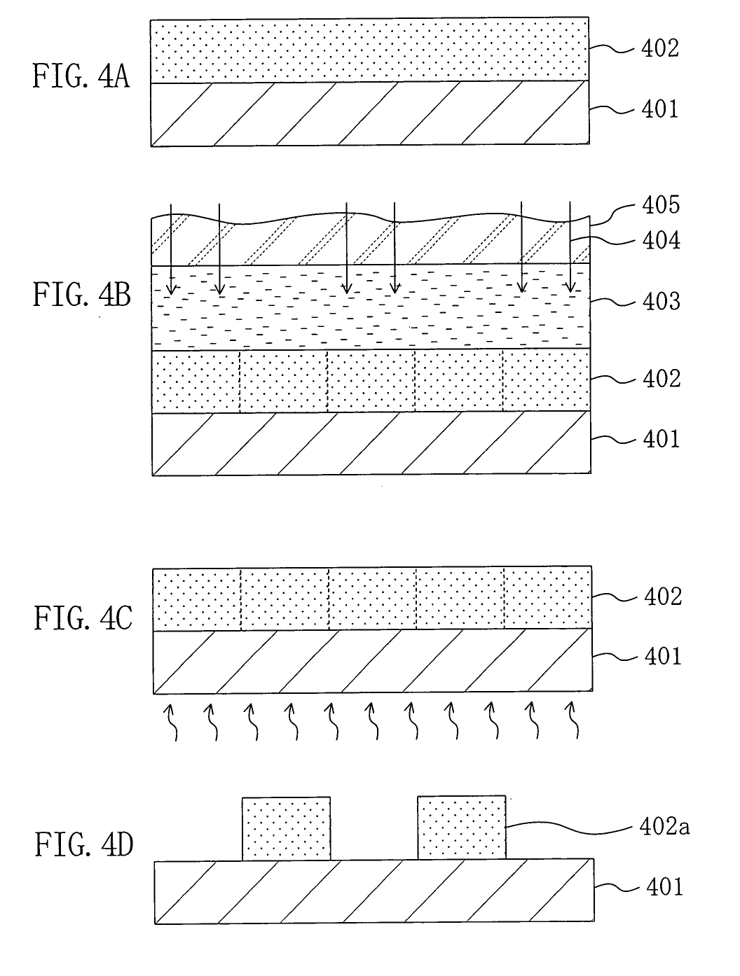

A chemically amplified resist material and a pattern formation method using the same according to Embodiment 4 of the invention will now be described with reference to FIGS. 4A through 4D.

First, a positive chemically amplified resist material having, for example, the following composition is prepared:

| | | |
|---|---|---|
| Base polymer: poly((2-methyl-2-adamantyl | 2 | g |
| methacrylate) (50 mol %)-(γ-butyrolactone methacrylate) | | |
| (40 mol %)-(2-hydroxyadamantyl methacrylate) | | |
| (10 mol %)) | | |
| Dissolution inhibitor: di-adamantyloxymethyl fumarate | 0.4 | g |
| Photo-acid generator: triphenylsulfonium trifluoromethane | 0.06 | g |
| sulfonate | | |
| Quencher: triethanolamine | 0.001 | g |
| Solvent: propylene glycol monomethyl ether acetate | 20 | g |

Next, as shown in FIG. 4A, the aforementioned chemically amplified resist material is applied on a substrate 401 so as to form a resist film 402 with a thickness of 0.35 μm.

Then, as shown in FIG. 4B, an immersion liquid 403 of water is provided between the resist film 402 and a projection lens 405. In this state, pattern exposure is carried out by irradiating the resist film 402 with exposing light 404 of ArF excimer laser with NA of 0.68 through a mask not shown.

After the pattern exposure, as shown in FIG. 4C, the resist film 402 is baked with a hot plate at a temperature of 115° C. for 60 seconds. Thereafter, the resultant resist film 402 is developed with a 0.26 N tetramethylammonium hydroxide developer. Thus, a resist pattern 402a made of an unexposed portion of the resist film 402, having a line width of 0.09 μm and having high resolution is formed as shown in FIG. 4D.

In this manner, according to Embodiment 4, the chemically amplified resist material includes the dissolution inhibitor of the di-adamantyloxymethyl fumarate, that is, fumaric acid substituted by a first acid labile group of an adamantyloxymethyl group. Therefore, the dissolution is accelerated in an exposed portion of the resist film 402 because the adamantyloxymethyl group is released by an acid generated from the photo-acid generator therein, and on the other hand, the dissolution rate is lowered in an unexposed portion because no adamantyloxymethyl group is released therein. As a result, the contrast is improved in the resist film 402 in the development, so that the resist pattern 402a can be formed in a good shape.

In addition, the base polymer is substituted by a second acid labile group, that is, a 2-methyl-2-adamantyl group in this embodiment, and hence, the dissolution inhibiting effect attained in the unexposed portion can be further increased. Specifically, the dissolution rate attained in the unexposed portion is further lowered, so as to further improve the contrast.

In each of Embodiments 1 through 4, the acid labile group may be a t-butyloxycarbonyl group, a methoxymethyl group or an ethoxyethyl group instead of a t-butyl group, a 2-methyl-2-adamantyl group or an adamantyloxymethyl group.

In each of Embodiments 1 through 4, the base polymer may be polyacrylic acid, polymethacrylic acid, polynorbornene methyl carboxylic acid, polynorbornene carboxylic acid, polynorbornene methyl hexafluoroisopropyl alcohol, polynorbornene hexafluoroisopropyl alcohol or polyvinyl phenol.

Furthermore, in each of Embodiments 1 through 4, the photo-acid generator may be 1,3-diphenyl diazodisulfone instead of triphenylsulfonium nonafluorobutane sulfonate or triphenylsulfonium trifluoromethane sulfonate.

Moreover, although the immersion liquid 303 or 403 is water in each of Embodiments 3 and 4, an acidic solution such as a cesium sulfate (Cs₂SO₄) aqueous solution or a phosphoric acid (H₃PO₄) aqueous solution may be used instead of the water. The concentration of the acidic aqueous solution is preferably 50 wt % or less, which does not limit the invention.

Although the exposing light is ArF excimer laser in each of Embodiments 1 through 4, the exposing light may be KrF excimer laser, Xe₂ laser, F₂ laser, KrAr laser or Ar₂ laser instead.

Also, in each of Embodiments 1 and 2, the exposing light may be extreme ultraviolet (EUV) or electron beam (EB).

As described so far, according to the chemically amplified resist material and the pattern formation method using the same of this invention, a resist pattern with high resolution can be formed in a good shape with exposing light of a 300 nm or shorter wavelength. Therefore, the invention is useful for a chemically amplified resist material suitably used in fine pattern processing for semiconductor devices and a pattern formation method using the same.

What is claimed is:

1. A chemically amplified resist material comprising:
fumaric acid substituted by an acid labile group released by an acid;
an alkali-soluble polymer soluble in an alkaline solution; and
a photo-acid generator for generating an acid through irradiation with light.

2. The chemically amplified resist material of claim 1,
wherein said acid labile group is a t-butyl group, a t-butyloxycarbonyl group, a methoxymethyl group, an adamantyloxymethyl group, an ethoxyethyl group or a 2-methyl-2-adamantyl group.

3. The chemically amplified resist material of claim 1,
wherein said alkali-soluble polymer is polyacrylic acid, polymethacrylic acid, polynorbornene methyl carboxylic acid, polynorbornene carboxylic acid, polynorbornene methyl hexafluoroisopropyl alcohol, polynorbornene hexafluoroisopropyl alcohol or polyvinyl phenol.

4. The chemically amplified resist material of claim 1,
wherein said photo-acid generator is triphenylsulfonium nonafluorobutane sulfonate, triphenylsulfonium trifluoromethane sulfonate or 1,3-diphenyl diazodisulfone.

5. A chemically amplified resist material comprising:
fumaric acid substituted by a first acid labile group released by an acid;
a polymer in which an alkali-soluble polymer soluble in an alkaline solution is substituted by a second acid labile group; and
a photo-acid generator for generating an acid through irradiation with light.

6. The chemically amplified resist material of claim 5,
wherein said first acid labile group is a t-butyl group, a t-butyloxycarbonyl group, a methoxymethyl group, an adamantyloxymethyl group, an ethoxyethyl group or a 2-methyl-2-adamantyl group.

7. The chemically amplified resist material of claim 5,
wherein said second acid labile group is a t-butyl group, a t-butyloxycarbonyl group, a methoxymethyl group, an adamantyloxymethyl group, an ethoxyethyl group or a 2-methyl-2-adamantyl group.

8. The chemically amplified resist material of claim 5,
wherein said alkali-soluble polymer is polyacrylic acid, polymethacrylic acid, polynorbornene methyl carboxylic acid, polynorbornene carboxylic acid, polynorbornene methyl hexafluoroisopropyl alcohol, polynorbornene hexafluoroisopropyl alcohol or polyvinyl phenol.

9. The chemically amplified resist material of claim 5,
wherein said photo-acid generator is triphenylsulfonium nonafluorobutane sulfonate, triphenylsulfonium trifluoromethane sulfonate or 1,3-diphenyl diazodisulfone.

10. A pattern formation method comprising the steps of:
forming, on a substrate, a resist film by using a chemically amplified resist material including fumaric acid substituted by a first acid labile group released by an acid, an alkali-soluble polymer soluble in an alkaline solution, and a photo-acid generator for generating an acid through irradiation with light;
performing pattern exposure by selectively irradiating said resist film with exposing light; and
forming a resist pattern by developing said resist film after the pattern exposure.

11. The pattern formation method of claim 10,
wherein said alkali-soluble polymer is substituted by a second acid labile group released by an acid.

12. The pattern formation method of claim 10,
wherein said first acid labile group is a t-butyl group, a t-butyloxycarbonyl group, a methoxymethyl group, an adamantyloxymethyl group, an ethoxyethyl group or a 2-methyl-2-adamantyl group.

13. The pattern formation method of claim 10,
wherein said alkali-soluble polymer is polyacrylic acid, polymethacrylic acid, polynorbornene methyl carboxylic acid, polynorbornene carboxylic acid, polynorbornene methyl hexafluoroisopropyl alcohol, polynorbornene hexafluoroisopropyl alcohol or polyvinyl phenol.

14. The pattern formation method of claim 10,
wherein said photo-acid generator is triphenylsulfonium nonafluorobutane sulfonate, triphenylsulfonium trifluoromethane sulfonate or 1,3-diphenyl diazodisulfone.

15. The pattern formation method of claim 10,
wherein said exposing light is extreme ultraviolet (EUV) or electron beam (EB).

16. The pattern formation method of claim 10,
wherein said exposing light is ArF excimer laser, KrF excimer laser, Xe₂ laser, F₂ laser, KrAr laser or Ar₂ laser.

17. A pattern formation method comprising the steps of:
forming, on a substrate, a resist film by using a chemically amplified resist material including fumaric acid substituted by a first acid labile group released by an acid, an alkali-soluble polymer soluble in an alkaline solution, and a photo-acid generator for generating an acid through irradiation with light;
performing pattern exposure by selectively irradiating said resist film with exposing light with a liquid provided on said resist film; and
forming a resist pattern by developing said resist film after the pattern exposure.

18. The pattern formation method of claim 17,
wherein said alkali-soluble polymer is substituted by a second acid labile group released by an acid.

19. The pattern formation method of claim 18,
wherein said second acid labile group is a t-butyl group, a t-butyloxycarbonyl group, a methoxymethyl group, an adamantyloxymethyl group, an ethoxyethyl group or a 2-methyl-2-adamantyl group.

20. The pattern formation method of claim 17,
wherein said first acid labile group is a t-butyl group, a t-butyloxycarbonyl group, a methoxymethyl group, an adamantyloxymethyl group, an ethoxyethyl group or a 2-methyl-2-adamantyl group.

21. The pattern formation method of claim 17,
wherein said alkali-soluble polymer is polyacrylic acid, polymethacrylic acid, polynorbornene methyl carboxylic acid, polynorbornene carboxylic acid, polynorbornene methyl hexafluoroisopropyl alcohol, polynorbornene hexafluoroisopropyl alcohol or polyvinyl phenol.

22. The pattern formation method of claim 17,
wherein said photo-acid generator is triphenylsulfonium nonafluorobutane sulfonate, triphenylsulfonium trifluoromethane sulfonate or 1,3-diphenyl diazodisulfone.

23. The pattern formation method of claim 17,
wherein said liquid is water.

24. The pattern formation method of claim 17,
wherein said liquid is an acidic solution.

25. The pattern formation method of claim 24,
wherein said acidic solution is a cesium sulfate aqueous solution or a phosphoric acid aqueous solution.

26. The pattern formation method of claim 17,
wherein said exposing light is ArF excimer laser, KrF excimer laser, Xe₂ laser, F₂ laser, KrAr laser or Ar₂ laser.
